(19) United States
(12) Patent Application Publication
(10) Pub. No.: US 2026/0016361 A1
(43) Pub. Date: Jan. 15, 2026

(54) DETECTING DEFECTS IN SEMICONDUCTOR MATERIAL

(71) Applicant: Wolfspeed, Inc., Durham, NC (US)

(72) Inventors: Jacob William Collins, Raleigh, NC (US); Justin Mossman, Angier, NC (US); Robert Mangum, Wake Forest, NC (US); Robert Metzger, Chapel Hill, NC (US); Robert Duttera, Wake Forest, NC (US); Keith Gyalog, Clayton, NC (US); Robert Williams, Roxboro, NC (US)

(21) Appl. No.: 18/770,846

(22) Filed: Jul. 12, 2024

(51) Int. Cl. G01M 3/20

(52) U.S. Cl. CPC G01M 3/205

(57) ABSTRACT

A method for detecting a defect in a semiconductor material includes positioning a first surface of the semiconductor material against a sealing component. The method further includes forming a pressure differential in a fluid between a first surface of a semiconductor material positioned against the sealing component and a second surface of the semiconductor material opposite the first surface. The method further includes sensing a leak of the fluid through the semiconductor material. Related methods and apparatus also are provided.

### TECHNICAL FIELD

The present disclosure relates to semiconductor materials and, more particularly, to detecting defects, such as micropipes, in semiconductor materials.

### BACKGROUND

Silicon carbide (SiC) exhibits many attractive electrical and thermophysical properties. SiC is especially useful due to its physical strength and high resistance to chemical attack as well as various electronic properties, including radiation hardness, high breakdown field, a relatively wide band gap, high saturated electron drift velocity, high temperature operation, and absorption and emission of high energy photons in the blue, violet, and ultraviolet regions of the spectrum. Compared with conventional wafer or substrate materials, including silicon and sapphire, such properties of SiC make it more suitable for the fabrication of wafers or substrates for high power density solid state devices, such as power electronic, radio frequency, and optoelectronic devices. SiC occurs in many different crystal structures called polytypes, with certain common polytypes (e.g., 4H—SiC and 6H—SiC) having a hexagonal crystal structure.

While SiC exhibits superior materials properties, crystal growth techniques required to grow SiC are very different and significantly more challenging than conventional growth processes for other crystalline materials. Conventional crystalline materials utilized in semiconductor manufacturing, such as silicon and sapphire, have significantly lower melting points, allowing for direct crystal growth techniques from melted source materials that enable fabrication of large diameter crystalline materials. In contrast, bulk crystalline SiC is often produced by a seeded sublimation growth process at high temperatures where various challenges include impurity incorporation, structural defects associated with thermal and crystallographic stress, and formation of unintended polytypes, among others. In a typical SiC growth technique, a substrate and a source material are both placed inside of a reaction crucible. A thermal gradient created when the crucible is heated encourages vapor phase movement of the materials from the source material to the substrate followed by condensation upon the substrate and resulting bulk crystal growth. It is known that impurities can be introduced as dopants into SiC and that these dopants can regulate certain properties. For sublimation growth of SiC, a dopant can be introduced into the chamber in a variety of manners so that the dopant will be present in the SiC crystal produced from that process. The process is controlled to provide an appropriate concentration of the dopant for a particular application. Following bulk crystal growth, individual wafers of SiC may be obtained by slicing a bulk crystal ingot or boule of SiC, and the individual wafers may subsequently be subjected to additional processes, such as lapping or polishing.

The unique properties of SiC wafers enable the design and fabrication of an array of high power and/or high frequency semiconductor devices. Continuous development has led to a level of maturity in the fabrication of SiC wafers that allows such semiconductor devices to be manufactured for increasingly widespread commercial applications. As the semiconductor device industry continues to mature, SiC wafers having larger usable diameters are desired. Usable diameters of SiC wafers can be limited by certain structural defects in the material composition of SiC as well as certain wafer shape characteristics. Structural defects in the material composition may include dislocations (e.g., micropipes, threading edge, threading screw and/or basal plane dislocations), hexagonal voids, and stacking faults, among others. Wafer shape characteristics associated with SiC may include warp, bow, and thickness variation that can relate to wafer flatness. These various structural defects and wafer shape characteristics can contribute to crystallographic stresses that can be detrimental to fabrication and proper operation of semiconductor devices subsequently formed on conventional SiC wafers.

Group Ill-Nitride based or gallium nitride (GaN) based high-electron mobility transistors (HEMTs) are very promising candidates for high power radiofrequency (RF) applications, both in discrete and MMIC (Monolithic Microwave Integrated Circuit) forms. Current GaN HEMT designs use buffer layers among other techniques that may help to reduce defects. However, defects, such as cracks, may be present.

It is difficult to detect some defects in SiC and other semiconductor materials. The art continues to seek improved SiC and other semiconductor materials and related solid-state devices while overcoming challenges associated with detecting defects.

### SUMMARY

A method for detecting a defect in a semiconductor material is disclosed, The method includes positioning a first surface of the semiconductor material against a sealing component; and forming a pressure differential in a fluid between a first surface of a semiconductor material positioned against the sealing component and a second surface of the semiconductor material opposite the first surface. The method further includes sensing a leak of the fluid through the semiconductor material.

The sealing component may include a material that conforms to a shape of the semiconductor material.

The sealing component may include a plurality of portions that respectively comprise a different respective sizes configured to conform to a size of the semiconductor material.

The sealing component may include an o-ring.

Sealing may include sensing a change in the pressure differential.

The fluid may include air, and sensing the change in the pressure differential may include, over a specified time period, measuring a total change of pressure as air leaks through at least one defect in the semiconductor material.

An amount of total change of pressure may determine whether the semiconductor material passes or fails the method for detecting a defect.

The sensing may include sensing, with a respective sensor from a plurality of sensors a change in the pressure differential for a respective portion of the semiconductor material that corresponds to the respective sensor.

The fluid may include an inert gas, and sensing can include sensing the change in the pressure differential with a mass spectrometer sensor that senses that the inert gas leaks through the semiconductor material.

The method according to some embodiments further includes placing the semiconductor material on a vacuum enabled pedestal, and positioning may include moving the vacuum enabled pedestal to position the semiconductor material against the sealing component.

The method according to some other embodiments further includes closing a cover above the first surface of the semiconductor material, and positioning may include applying a downward pressure on the cover to aid in forming a seal between the semiconductor material and the sealing component.

The method according to yet other embodiments further includes automatically removing the semiconductor material from the sealing component; and repeating the positioning, the forming, and the sensing for another semiconductor material.

Forming the pressure differential in the fluid between the first surface of the semiconductor material positioned against the sealing component and the second surface of the semiconductor material opposite the first surface may include forming the pressure differential in a plurality of chambers beneath the sealing component; and sensing a leak of the fluid through the semiconductor material may include sensing with a plurality of sensors including at least one sensor per chamber of the plurality of chambers, and a respective sensor from a plurality of sensors senses a change in the pressure differential for a respective portion of the semiconductor material that corresponds to the respective sensor.

The semiconductor material may be a wafer and may include a diameter of at least one of 100 mm, 150 mm, and 200 mm.

The semiconductor material may be a silicon carbide wafer.

The defect may be a micropipe.

In other embodiments, an apparatus is provided that is configured for detecting a defect in a semiconductor material. The apparatus includes a sealing component; and a chamber beneath the sealing component configured to form at least one of a pressure differential in a fluid between a first surface of the semiconductor material positioned against the sealing component and a second surface of the semiconductor material opposite the first surface. The apparatus further includes a sensor configured to sense a leak of the fluid through the semiconductor material.

The sealing component may include a material that can conform to a shape of the semiconductor material.

The sealing component may include a plurality of portions that respectively include a different respective size configured to conform to a size of the semiconductor material.

The sealing component may include an o-ring.

The sensor may be configured to sense a change in the pressure differential.

The fluid may include air, and the sensor may sense the change in the pressure differential, over a specified time period, based on a measurement of a total change of pressure as air leaks through at least one defect in the semiconductor material.

An amount of total change of pressure may determine whether the semiconductor material passes or fails detecting a defect.

The sensor may include a plurality of sensors and a respective sensor from the plurality of sensors may sense a change in the pressure differential for a respective portion of the semiconductor material that corresponds to the respective sensor.

The fluid may include an inert gas, and the sensor may include a mass spectrometer sensor configured to sense that the inert gas leaks through the semiconductor material.

The apparatus according to some embodiments further includes a vacuum enabled pedestal configured for placement of the semiconductor material on the vacuum enabled pedestal and movement of the vacuum enabled pedestal to position the semiconductor material against the sealing component.

The apparatus according to some other embodiments further includes a cover configured to be closed above the first surface of the semiconductor material; and a mechanism configured to apply a downward pressure on the cover to aid in forming a seal between the semiconductor material and the sealing component.

The chamber may include a plurality of chambers beneath the sealing component configured to form a pressure differential in the fluid between the first surface of the semiconductor material positioned against the sealing component and the second surface of the semiconductor material opposite the first surface; and the sensor may include a plurality of sensors including at least one sensor per chamber of the plurality of chambers, and a respective sensor from a plurality of sensors senses a change in the pressure differential for a respective portion of the semiconductor material that corresponds to the respective sensor.

The semiconductor material may be a wafer and may include a diameter of at least one of 100 mm, 150 mm, and 200 mm.

The semiconductor material may include a silicon carbide wafer.

### BRIEF DESCRIPTION OF DRAWINGS

FIG. 1 illustrates an apparatus according to some embodiments.

FIG. 2 illustrates a perspective view of the apparatus of FIG. 1 according to some embodiments.

FIG. 3 illustrates a top view of a pedestal, support and sealing component of the apparatus of FIGS. 1 and 2 according to some embodiments.

FIG. 4 illustrates a cross-sectional view of another apparatus according to some embodiments.

FIG. 5 illustrates a further example of an apparatus according to some embodiments.

FIG. 6 is a plot showing pressure versus time according to some embodiments.

FIG. 7 is a block diagram illustrating operations for detecting a defect in a semiconductor material according to some embodiments.

### DETAILED DESCRIPTION

Embodiments of the inventive concepts are explained more fully with reference to the non-limiting aspects and examples that are described and/or illustrated in the accompanying drawings and detailed in the following description. It should be noted that the features illustrated in the drawings are not necessarily drawn to scale, and features of some embodiments may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element or region to another element or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art.

Although some embodiments are described in the context of a SiC, it will be appreciated that aspects of the inventive concepts may be applicable to other types of semiconductor materials that include a defect, such as gallium nitride (GaN) wafers, gallium arsenide (GaAs) wafers, and other types of semiconductor materials.

Although some embodiments are described in the context of a defect that is a micropipe, it will be appreciated that aspects of the inventive concepts may be applicable to other types of defects in semiconductor materials, such as dislocations forming holes and hexagonal voids, among others.

Due to defects in a 4H crystal structure of SiC, during a growth process, SiC boules can develop micropipes that can be holes that permeate the crystal and may expand along the length of the boule. As the boule is processed into wafers to be used as a substrate, for example, one or more micropipes may present as holes in the wafer that can cause a photoresist chemical to pass through the wafer and contaminate the backside of the wafer or a wafer processing tool. This, in turn, can reduce the yield of wafers from a boule for both a wafer manufacturer and customers of the wafer manufacturer who purchase a substrate at the polish phase of processing.

An approach that checks for defects in a semiconductor material, such as a SiC wafer, is manual and includes an operator spreading water as evenly as possible across a frontside surface of the SiC wafer; pulling a vacuum from a backside of the SiC wafer; and then visually inspecting the backside of the SiC wafer to visually determine whether water was pulled through the SiC wafer. The SiC wafer is passed or failed based on the presence or absence of water pulled through the SiC wafer.

One potential drawback of such an approach is the need to have an even spread of water across the SiC wafer to test the entire SiC wafer. Water, however, typically may not stay evenly spread across the SiC wafer, leaving parts of the SiC wafer untested. Another potential drawback is that such an approach is a manual approach that includes a subjective, visual inspection by an operator to determine whether water was pulled through the SiC wafer. Moreover, the approach provides a pass/fail result without any quantification of number and/or size of defects present.

In some embodiments, a fluid such as air or an inert gas is pulled or leaks through the semiconductor material wafer, rather than water. As a consequence, the full semiconductor material (e.g., a wafer) is tested. Air or an inert gas is more likely to pass through a defect than water. Thus, sensitivity of detecting defects may be increased. Moreover, the method of some embodiments is automated and, thus, may remove effects of operator error. Additionally or alternatively, in some embodiments, a rate of leak of a vacuum or inert gas is sensed. As a result, a range of data may be provided, depending on the number and size of defects, such as micropipes, present in the semiconductor material under test.

In particular, in some embodiments, a robot selects a semiconductor material from a caseate/holder and places the semiconductor material onto a central stand/pedestal of an apparatus. The semiconductor material is held on the stand/pedestal using a vacuum; and the stand/pedestal lowers the semiconductor material onto a sealing component of the apparatus, where the semiconductor material if held with some force. While the semiconductor material is held against the sealing component, a vacuum is formed in a chamber of the apparatus underneath the semiconductor material. Over a specified time period, a sensor of the apparatus senses a total change in pressure as air or an inert gas, for example, is pulled through defects (e.g., holes) in the semiconductor material. In this example, the semiconductor material passes or fails based on how much the vacuum or inert gas leaks over the test time. A robot then places the semiconductor material back in the cassette/holder and moves onto another semiconductor material to test.

In some embodiments, an apparatus is configured for detecting a defect in a semiconductor material. The apparatus includes a sealing component; and a chamber beneath the sealing component configured to form at least one of a pressure differential in a fluid between a first surface of the semiconductor material positioned against the sealing component and a second surface of the semiconductor material opposite the first surface. The apparatus further includes a sensor configured to sense a leak of the fluid through the semiconductor material. The sealing component may include a material that can conform to a shape of the semiconductor material. In some embodiments, the sealing component includes an o-ring.

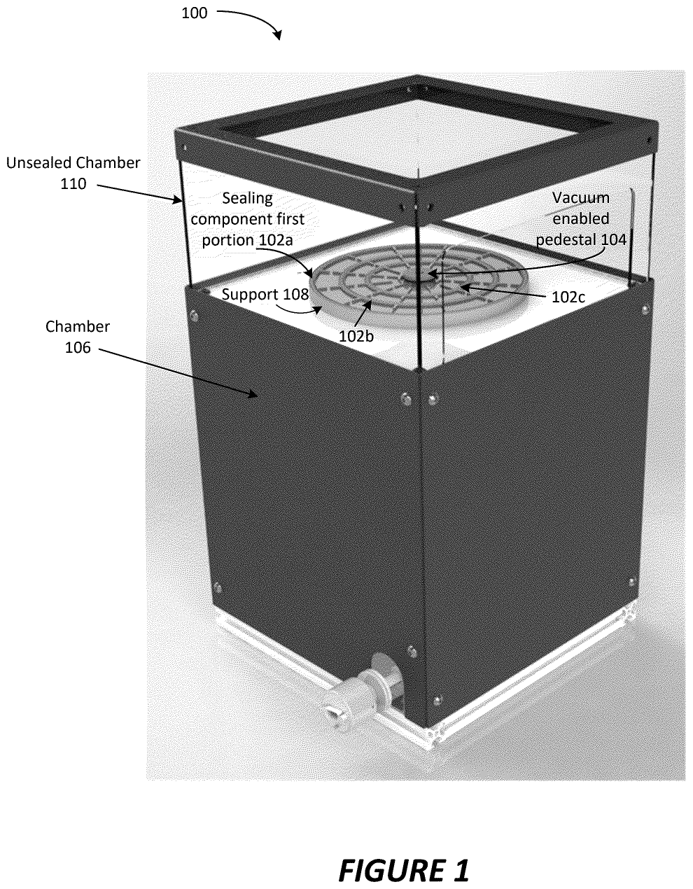

For example, FIG. 1 illustrates an apparatus 100 according to some embodiments. In particular, FIG. 1 shows an apparatus 100 that includes an enclosed chamber 106 and an unsealed chamber 110. The unsealed chamber 110 includes a support 108, and a sealing component 102 on the support 108.

The sealing component 102 may include a plurality of portions that respectively include a different respective size configured to conform to a size of the semiconductor material. For example, as shown in the example in FIG. 1, the sealing component 102 includes portions 102a, 102b, 102c configured for different sized semiconductor materials such as wafers. First portion 102a is configured for larger wafers, e.g. 200 mm diameter wafers; second portion 102b is configured for a smaller wafer, e.g., 150 mm diameter wafers; and third portion 102c is configured for still smaller wafers, e.g., 100 mm diameter wafers.

Although the apparatus 100 of FIG. 1 is described in the context of a sealing component that has three portions 102a, 102b, 102c, it will be appreciated that aspects of the inventive concepts may be applicable to other configurations of the sealing component 102, such as a sealing component 102 that has one portion configured for one size of semiconductor materials (e.g., for a 200 mm diameter SiC wafer) or a sealing component 102 that has a plurality of portions other then three (e.g., two portions, four portions, etc.) for different sizes of semiconductor materials.

Additionally, although the apparatus of FIG. 1 is described in the context of a sealing component 102 that is circular, it will be appreciated that aspects of the inventive concepts may be applicable to other configurations of the sealing component 102, such as an ellipse, a circular pattern that includes notches, cut outs, or other shapes, among others.

Apparatus 100 also includes a vacuum enabled pedestal 104. The vacuum enabled pedestal 104 may be configured for placement of the semiconductor material on the vacuum enabled pedestal 104 and movement of the vacuum enabled pedestal 104 to position the semiconductor material against the sealing component 102.

In some examples, a robot (not shown) removes a semiconductor material, such as a SiC wafer in this example, from a cassette (not shown) and places the SiC wafer onto the vacuum enabled pedestal 104. The vacuum enabled pedestal 104 holds the SiC wafer using a vacuum, and lowers the SiC wafer to be positioned against the sealing component 102 on support 108. In this example, the SiC wafer is a 200 mm diameter wafer and the wafer is lowered to be positioned against first portion 102a of the sealing component 102. The SiC wafer is held against the first portion 102a of the sealing component 102 with some force.

While the SiC wafer is held against the first portion 102a of the sealing component 102, a vacuum is formed in the chamber 106 underneath the SiC wafer. A rate of rise (ROR) test is performed to sense a leak rate through the semiconductor material. For example, over a specified test time period, such as 80 seconds, the apparatus 100 measures a total change in pressure at a sensor in chamber 106 as air leaks through a defect(s) (e.g., a hole(s)) in the SiC wafer and through the support 108 to the chamber 106. The SiC wafer passes or fails based on how much the vacuum leaks over the test time period. The robot then places the SiC wafer back in the cassette and moves onto another SiC wafer for testing.

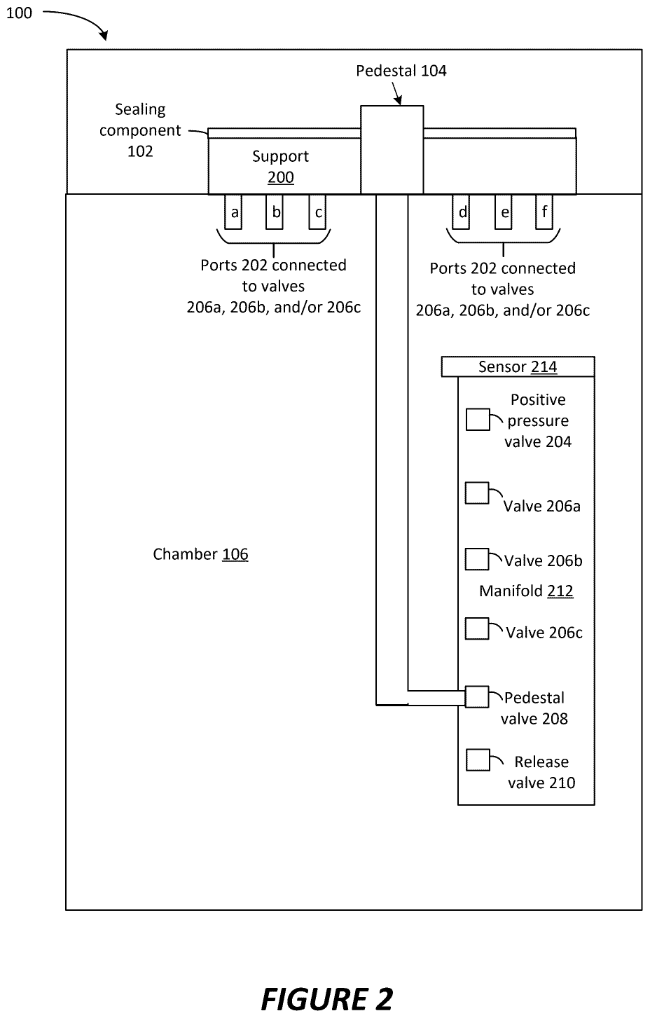

FIG. 2 illustrates a perspective view of apparatus 100. In particular, FIG. 2 shows the interior of chamber 106 and a side view of sealing component 102, pedestal 104, and support 200 in unsealed chamber 110.

The interior of chamber 106 in this example includes a manifold 212. The manifold 212 includes a number of valves. Valve 204 is a positive pressure valve to apply air pressure to the semiconductor material positioned against the sealing component 102 to aid in removal of the semiconductor material from the apparatus 102. Valve 206a is connected to ports 202, specifically ports 202a-20f. Valve 206a controls air to apply the vacuum when a semiconductor material, such as a 200 mm diameter SiC wafer, is positioned against first portion 102a of sealing component 102. Valve 206b is connected to a subset of ports 202, specifically ports 202b, 202c, 202d, and 202e. Valve 206b controls air to apply the vacuum when a semiconductor material, such as a 150 mm diameter SiC wafer, is positioned against second portion 102b of sealing component 102. Valve 206c is connected to a subset of ports 202, specifically ports 202c and 202d. Valve 206c controls air to apply the vacuum when a semiconductor material, such as a 100 mm diameter SiC wafer, is positioned against third portion 102c of sealing component 102.

Valves 206a, 206b, 206c may be solenoid valves connected via flexible tubing, for example, to the ports 202 discussed above.

Pedestal valve 208 is connected to pedestal 104 via dedicated tubing as shown in FIG. 2, for example. Pedestal valve 208 operates to hold the semiconductor material on pedestal 104 and to lower/raise the semiconductor material to/from the sealing component 102.

Release valve 210 releases chamber 106 to atmosphere.

Chamber 106 also includes a sensor 214. Sensor 214 may be configured to sense a change in the pressure differential in chamber 106. In the example discussed above when the fluid is air, sensor 214 is a pressure gauge that senses a leak of the air through a defect(s) in the semiconductor material, through the support 108 and to the chamber 106. In particular, sensor 214 may sense an increase in pressure in chamber 106, over a specified time period, based on a measurement of a total change of pressure as air leaks through at least one defect in the semiconductor material, through the support 108 and to the chamber 106. An amount of total change of pressure in chamber 106 may determine whether the semiconductor material passes or fails detecting a defect.

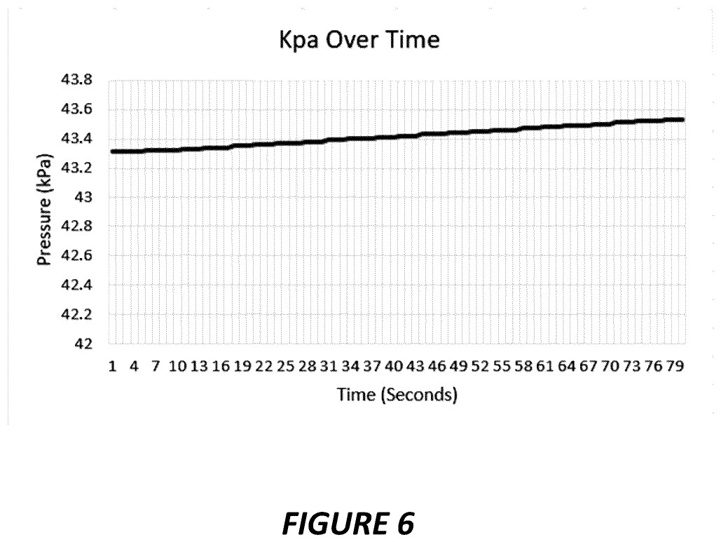

Sensor 214 is connected to a computing device (not shown). The computing device is configured to control the testing including, without limitation, to control the valves 204, 206a, 206b, 206b, 208, 210; to collect data from the sensor 214 over the test time period; and to analyze the data from sensor 214 by, for example, comparing the collected data to a preset or predefined threshold pressure value that indicates that air is leaking through the semiconductor material to the chamber 106. For example, FIG. 6 illustrates a plot of data collected from sensor 214. In the example in FIG. 6, the plot shows pressure versus time over a test time period of 80 seconds. As shown in the example in FIG. 6, the starting value is 43.3 KPa, which varies slightly as the chamber 106 is pumped down to −55 KPa from atmospheric pressure. The total change in pressure over the test time period of 80 seconds in FIG. 6 is 0.20 Kpa (final value of 43.5 KPa-initial value of 43.3 KPa). In this example, a predefined threshold value of overall change in pressure over the test time period for passing the leak test is 0.30 KPa. Thus, FIG. 6 shows an example of a total leak rate that is considered passing. While FIG. 6 is described with reference to particular initial, final, pump down, and predefined threshold pressure values, it is to be understood that some embodiments of the present disclosure may include different pressure values.

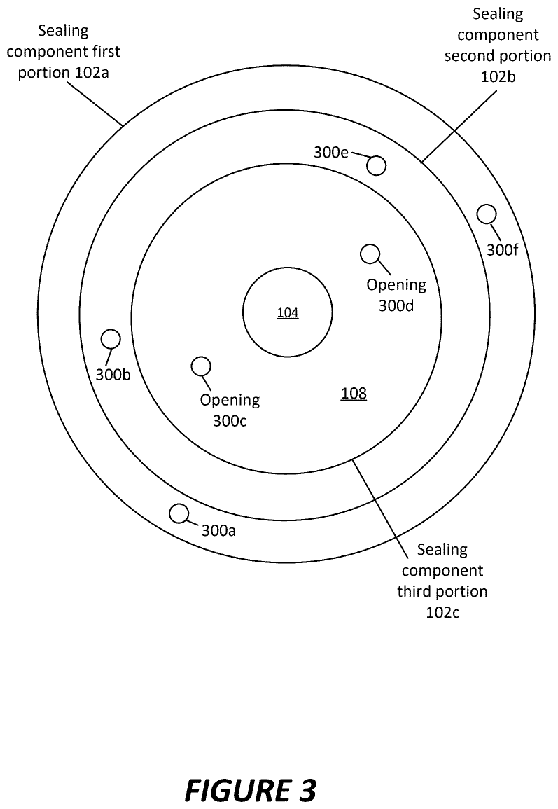

FIG. 3 illustrates a top view of pedestal 104, support 108 and sealing component 102. In particular, FIG. 3 shows sealing component first portion 102a, sealing component second portion 102b, and sealing component third portion 102c. Openings 300a-300f are the openings of ports 202a-202f discussed above.

When a semiconductor material, such as a 200 mm diameter SiC wafer, is positioned against first portion 102a of sealing component 102, valve 206a is connected to ports 202a, 202b, 202c, 202d, 202e, 202f and creates a vacuum in chamber 106. Ports 202a, 202b, 202c, 202d, 202e, 202f respectively include openings 300a, 300b, 300c, 300d, 300e, and 300f. If the semiconductor material positioned against sealing component first portion 102a, includes one or more defects, air leaks through one or more of openings 300a, 300b, 300c, 300d, 300e, and 300f depending on the number and location of the defects. Sensor 214 of apparatus 100 senses a total change in pressure as the air leaks through the one more defects in the semiconductor material and the one or more openings 300a, 300b, 300c, 300d, 300e, 300f. In this example, the semiconductor material passes or fails based on how much the pressure changes as the air leaks over the test time.

In another example, when a semiconductor material, such as a 150 mm diameter SiC wafer, is positioned against second portion 102b of sealing component 102, valve 206b is connected to ports 202b, 202c, 202d, 202e and creates a vacuum in chamber 106. Ports 202b, 202c, 202d, 202e respectively include openings 300b, 300c, 300d, and 300e. If the semiconductor material positioned against sealing component second portion 102b, includes one or more defects, air leaks through one or more of openings 300b, 300c, 300d, and 300e depending on the number and location of the defects. Sensor 214 of apparatus 100 senses a total change in pressure as the air leaks through the one more defects in the semiconductor material and the one or more openings 300b, 300c, 300d, 300e. In this example, the semiconductor material passes or fails based on how much the pressure changes as the air leaks over the test time.

In yet another example, when a semiconductor material, such as a 100 mm diameter SiC wafer, is positioned against third portion 102c of sealing component 102, valve 206c is connected to ports 202c, 202d and creates a vacuum in chamber 106. Ports 202c, 202d respectively include openings 300c and 300d. If the semiconductor material positioned against sealing component third portion 102c, includes one or more defects, air leaks through one or more of openings 300c, 300d depending on the number and location of the defects. Sensor 214 of apparatus 100 senses a total change in pressure as the air leaks through the one more defects in the semiconductor material and the one or more openings 300c, 300d. In this example, the semiconductor material passes or fails based on how much the pressure changes as the air leaks over the test time.

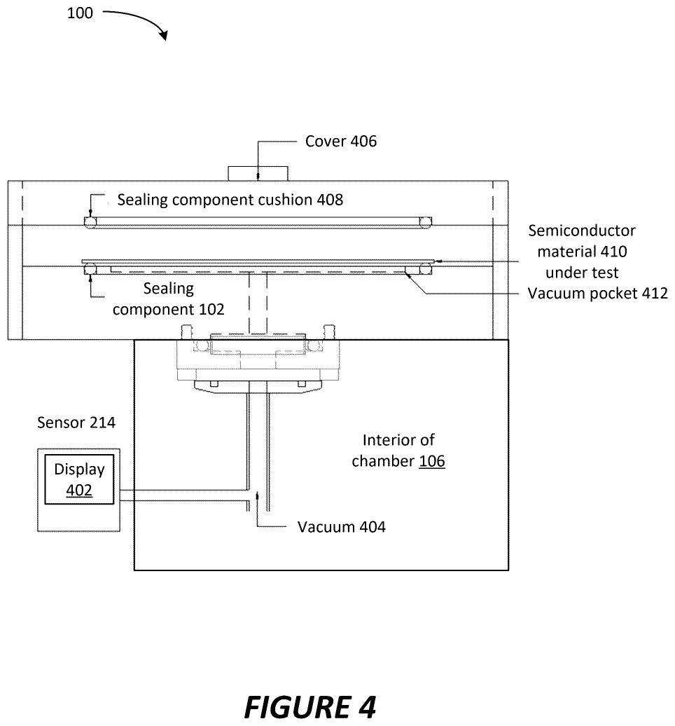

FIG. 4 illustrates a cross-sectional view of another example of apparatus 100. In particular, FIG. 4 shows apparatus 100 configured with a sealing component 102 for one size of a semiconductor material, e.g. for a 200 mm diameter wafer; and a vacuum 404 applied via a single connection to create a vacuum pocket 412 beneath the semiconductor material 410 under test. Additionally, in this example, sensor 214 is positioned on the exterior of chamber 106. Sensor 214 in this example also includes a display 402 on which a change in the pressure can be displayed in addition to, or alternatively, on a computing device.

This example of apparatus 100 shown in FIG. 4 further includes a cover 406 and a sealing component 408. The cover 406 may be configured to be closed above the first surface of the semiconductor material; and a mechanism, such as a sealing component cushion 408, may be configured to apply a downward pressure on the cover 406 to aid in forming a seal between the semiconductor material and the sealing component.

The apparatus 100 in FIG. 4, can identify one or more defects in the semiconductor material 410 by applying the vacuum 404 under the entire surface of the semiconductor material 410, and isolating the vacuum in vacuum pocket 412. A ROR test, as discussed above, is performed to sense a leak rate through the semiconductor material 410 and the sealing component 102 to the chamber 106. The semiconductor material 410 passes or fails depending on whether a leak is sensed.

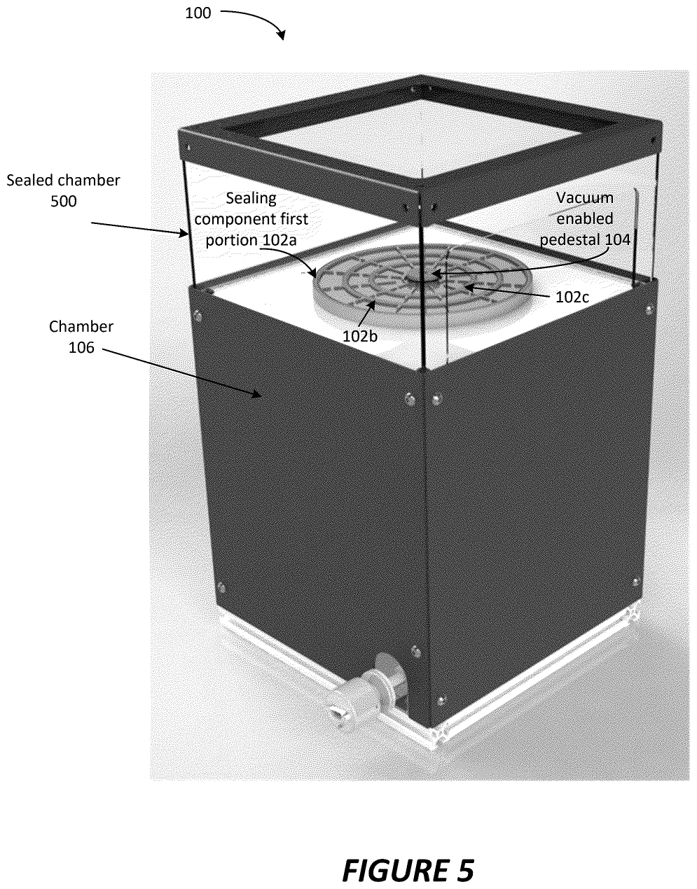

FIG. 5 illustrates a further example of apparatus 100. In particular, FIG. 5 shows apparatus 100 configured to detect one or more defects in a semiconductor material based on sensing a leak of an inert gas. The apparatus 100 is similar to the apparatus 100 shown in FIG. 1, except the apparatus 100 in FIG. 5 includes a sealed chamber 500 configured for an inert gas atmosphere. In FIG. 5, sensor 214 is a mass spectrometer included in a vacuum system as discussed above regarding FIGS. 1-3, and an additional valve (not shown) may apply an inert gas, such as helium or nitrogen for example, to the sealed chamber 500. In this example, sensor 214 is a mass spectrometer sensor configured to sense that the inert gas leaks from the sealed chamber 500, through the semiconductor material and openings 300 in support 108, to the chamber 106. Sensor 214 is connected to a computing device (not shown). The mass spectrometer may be highly sensitive and tuned to specifically admit, ionize, and detect the inert gas. The computing device is configured to control the testing including, without limitation, to control the valves 204, 206a, 206b, 206b, 208, 210 to apply the vacuum to chamber 106 and the inert gas valve to apply the inert gas to sealed chamber 500; and to analyze/collect data from the sensor 214 over the test time period that measures an amount of the inert gas leaking through the semiconductor material, the and openings 300 in support 108, to the chamber 106.

When a semiconductor material, such as a 200 mm diameter SiC wafer, is positioned against first portion 102a of sealing component 102, sensor 214 of apparatus 100 of FIG. 5 may sense a total change in pressure as the inert gas leaks through the one more defects in the semiconductor material and the one or more openings 300a, 300b, 300c, 300d, 300e, 300f. In this example, the semiconductor material passes or fails based on how much the inert gas leaks over the test time.

In another example, when a semiconductor material, such as a 150 mm diameter SiC wafer, is positioned against second portion 102b of sealing component 102, sensor 214 of apparatus 100 of FIG. 5 senses a total change in pressure as the inert gas leaks through the one more defects in the semiconductor material and the one or more openings 300b, 300c, 300d, 300e. In this example, the semiconductor material passes or fails based on how much the inert gas leaks over the test time.

In yet another example, when a semiconductor material, such as a 100 mm diameter SiC wafer, is positioned against third portion 102c of sealing component 102, sensor 214 of apparatus 100 senses a total change in pressure as the inert gas leaks through the one more defects in the semiconductor material and the one or more openings 300c, 300d. In this example, the semiconductor material passes or fails based on how much the inert gas leaks over the test time.

It will be appreciated that the apparatus 100 of FIG. 5 including a mass spectrometer as sensor 214 may be a more sensitive way of detecting a defect in a semiconductor material than the apparatus 100 of FIGS. 1-4, for example.

Although some embodiments are described in the context of a single compartment 106 and/or a single sensor 214, it will be appreciated that aspects of the inventive concepts may be applicable to other types of apparatus that include a plurality of components and/or a plurality of sensors to identify a location of one or more micropipes in the semiconductor materials with increased granularity.

For example, the apparatus 100 may include a plurality of sensors 214 and a respective sensor 214 from the plurality of sensors senses a change in the pressure differential for a respective portion of the semiconductor material that corresponds to the respective sensor.

In another example, the chamber 106 includes a plurality of chambers beneath the sealing component 102 configured to form a pressure differential in the fluid between the first surface of the semiconductor material positioned against the sealing component 102 and the second surface of the semiconductor material opposite the first surface. A plurality of sensors 214 may be included with at least one sensor 214 per chamber 106 of the plurality of chambers, and a respective sensor 214 from a plurality of sensors senses a change in the pressure differential for a respective portion of the semiconductor material that corresponds to the respective sensor.

In some embodiments, the semiconductor material is a wafer and includes a diameter of at least one of 100 mm, 150 mm, and 200 mm.

The semiconductor material may be a SiC wafer.

The defect may be a micropipe.

Although some embodiments are described in the context of applying a vacuum and detecting a leak in chamber 106, it will be appreciated that aspects of the inventive concepts may be applicable to other types of apparatus that include applying an overpressure in sealed chamber 500 of FIG. 5. While the semiconductor material is held against the sealing component 102, the overpressure is formed in sealed chamber 500 above the semiconductor material. Over a specified time period, a sensor of the apparatus, which may be positioned in or connected to sealed chamber 500, senses a total change in pressure sealed chamber 500 as air leaks through defects (e.g., holes) in the semiconductor material, through holes 300 in support 108, and into chamber 106. In this example, the semiconductor material passes or fails based on how much the overpressure leaks over the test time.

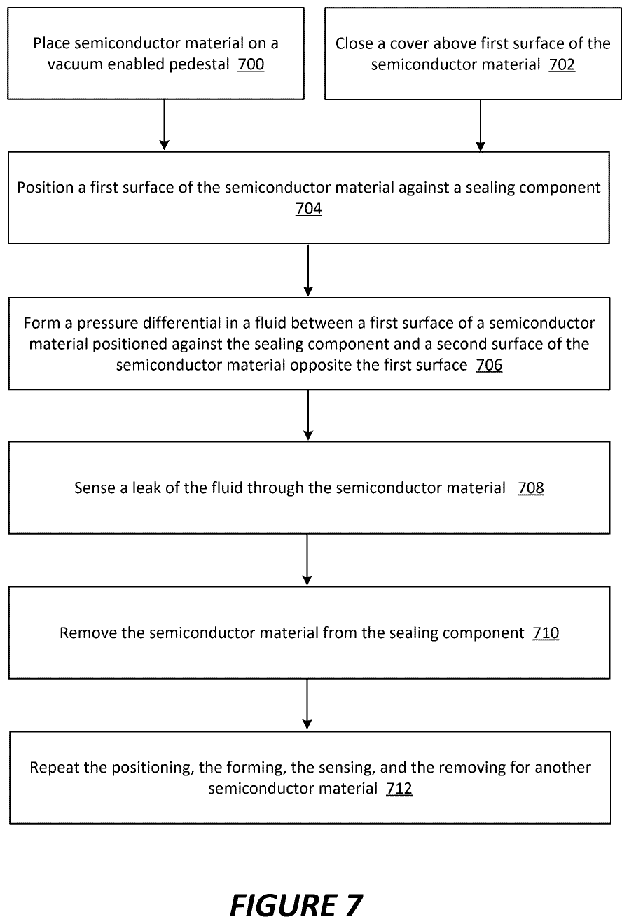

FIG. 7 is a block diagram illustrating operations for detecting a defect in a semiconductor material according to some embodiments. In particular, a method for detecting a defect in a semiconductor material includes, as shown in block 704, positioning a first surface of the semiconductor material against a sealing component. The method further includes, as shown in block 706, forming a pressure differential in a fluid between a first surface of a semiconductor material positioned against the sealing component and a second surface of the semiconductor material opposite the first surface. As shown in block 708, the method further includes sensing a leak of the fluid through the semiconductor material.

In some embodiments, as shown in block 700, the method further includes placing the semiconductor material on a vacuum enabled pedestal; and the positioning includes moving the vacuum enabled pedestal to position the semiconductor material against the sealing component.

In other embodiments, as shown in block 702, the method further includes closing a cover above the first surface of the semiconductor material; and the positioning includes applying a downward pressure on the cover to aid in forming a seal between the semiconductor material and the sealing component.

In still other embodiments, as shown in blocks 710 and 712, the method further includes removing the semiconductor material from the sealing component; and repeating the positioning, the forming, the sensing, and the removing for another semiconductor material. These operations may be performed automatically, including positioning and removing the semiconductor material from the sealing component by a robot, for example.

The inventive concepts have been described above with reference to the accompanying drawings, in which embodiments are shown. The inventive concepts may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Like numbers refer to like elements throughout, except where expressly noted.

It will be understood that although the terms first and second are used herein to describe various regions and/or elements, these regions and/or elements should not be limited by these terms. These terms are only used to distinguish one region or element from another region or element. Thus, a first region or element discussed herein could be termed a second region or element, and similarly, a second region or element may be termed a first region or element without departing from the scope of the present invention.

Relative terms, such as “lower” or “bottom” and “upper” or “top,” may be used herein to describe one element's relationship to another element as illustrated in the drawings. It will be understood that relative terms are intended to encompass different orientations of the device in addition to the orientation depicted in the drawings. For example, if the apparatus in the drawings is turned over, elements described as being on the “lower” side of other elements would then be oriented on “upper” sides of the other elements. The exemplary term “lower” can, therefore, encompass both an orientation of “lower” and “upper,” depending of the particular orientation of the figure. Similarly, if compartments of the apparatus in one of the figures is turned over, elements described as “below” or “beneath” other elements would then be oriented “above” the other elements. The exemplary terms “below” or “beneath” can, therefore, encompass both an orientation of above and below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, elements, and/or components, but do not preclude the presence or addition of one or more other features, elements, components, and/or groups thereof.

Embodiments of the inventive concepts are described herein with reference to cross-sectional illustrations that are schematic illustrations. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a sealing component illustrated as a circle will, typically, have straight or other features and/or a shape to exclude a wafer notch. Thus, the components, such as the sealing component, illustrated in the figures are schematic in nature and their shapes are not intended to illustrate the actual shape of a component of an apparatus and are not intended to limit the scope of the invention.

It will be understood that the embodiments disclosed herein can be combined. Thus, features that are pictured and/or described with respect to a first embodiment may likewise be included in a second embodiment, and vice versa.

While the above embodiments are described with reference to particular figures, it is to be understood that some embodiments of the present invention may include additional and/or intervening component, structures, or elements, and/or particular components, structures, or elements may be deleted. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method for detecting a defect in a semiconductor material, the method comprising:
positioning a first surface of the semiconductor material against a sealing component;
forming a pressure differential in a fluid between a first surface of a semiconductor material positioned against the sealing component and a second surface of the semiconductor material opposite the first surface; and
sensing a leak of the fluid through the semiconductor material.

2. The method of claim 1, wherein the sealing component comprises a material that conforms to a shape of the semiconductor material.

3. The method of claim 1, wherein the sealing component comprises a plurality of portions that respectively comprise a different respective sizes configured to conform to a size of the semiconductor material.

4. The method of claim 1, wherein the sealing component comprises an o-ring.

5. The method of claim 1, wherein the sensing comprises sensing a change in the pressure differential.

6. The method of claim 5, wherein the fluid comprises air, and the sensing the change in the pressure differential comprises, over a specified time period, measuring a total change of pressure as air leaks through at least one defect in the semiconductor material.

7. The method of claim 6, wherein an amount of total change of pressure determines whether the semiconductor material passes or fails the method for detecting a defect.

8. The method of claim 1, wherein the sensing comprises sensing, with a respective sensor from a plurality of sensors a change in the pressure differential for a respective portion of the semiconductor material that corresponds to the respective sensor.

9. The method of claim 1, wherein the fluid comprises an inert gas, and the sensing comprises sensing the change in the pressure differential with a mass spectrometer sensor that senses that the inert gas leaks through the semiconductor material.

10. The method of claim 1, further comprising:
placing the semiconductor material on a vacuum enabled pedestal,
wherein the positioning comprises moving the vacuum enabled pedestal to position the semiconductor material against the sealing component.

11. The method of claim 1, further comprising:
closing a cover above the first surface of the semiconductor material; and
wherein the positioning comprises applying a downward pressure on the cover to aid in forming a seal between the semiconductor material and the sealing component.

12. The method of claim 1, further comprising:
removing the semiconductor material from the sealing component; and
repeating the positioning, the forming, the sensing, and the removing for another semiconductor material.

13. The method of claim 1, wherein the forming the pressure differential in the fluid between the first surface of the semiconductor material positioned against the sealing component and the second surface of the semiconductor material opposite the first surface comprises forming the pressure differential in a plurality of chambers beneath the sealing component, and
wherein the sensing a leak of the fluid through the semiconductor material comprising sensing with a plurality of sensors comprising at least one sensor per chamber of the plurality of chambers, and a respective sensor from a plurality of sensors senses a change in the pressure differential for a respective portion of the semiconductor material that corresponds to the respective sensor.

14. The method of claim 1, wherein the semiconductor material is a wafer and comprises a diameter of at least one of 100 mm, 150 mm, and 200 mm.

15. The method of claim 1, wherein the semiconductor material comprises a silicon carbide wafer.

16. The method of claim 1, wherein the defect comprises a micropipe.

17. An apparatus configured for detecting a defect in a semiconductor material, the apparatus comprising:
a sealing component;
a chamber beneath the sealing component configured to form at least one of a pressure differential in a fluid between a first surface of the semiconductor material positioned against the sealing component and a second surface of the semiconductor material opposite the first surface; and
a sensor configured to sense a leak of the fluid through the semiconductor material.

18. The apparatus of claim 17, wherein the sealing component comprises a material that can conform to a shape of the semiconductor material.

19. The apparatus of claim 17, wherein the sealing component comprises a plurality of portions that respectively comprise a different respective size configured to conform to a size of the semiconductor material.

20. The apparatus of claim 17, wherein the sealing component comprises an o-ring.

21. The apparatus of claim 17, wherein the sensor is configured to sense a change in the pressure differential.

22. The apparatus of claim 21, wherein the fluid comprises air, and the sensor senses the change in the pressure differential, over a specified time period, based on a measurement of a total change of pressure as air leaks through at least one defect in the semiconductor material.

23. The apparatus of claim 22, wherein an amount of total change of pressure determines whether the semiconductor material passes or fails detecting a defect.

24. The apparatus of claim 17, wherein the sensor comprises a plurality of sensors and a respective sensor from the plurality of sensors senses a change in the pressure differential for a respective portion of the semiconductor material that corresponds to the respective sensor.

25. The apparatus of claim 17, wherein the fluid comprises an inert gas, and the sensor comprises a mass spectrometer sensor configured to sense that the inert gas leaks through the semiconductor material.

26. The apparatus of claim 17, further comprising:
a vacuum enabled pedestal configured for placement of the semiconductor material on the vacuum enabled pedestal and movement of the vacuum enabled pedestal to position the semiconductor material against the sealing component.

27. The apparatus of claim 17, further comprising:
a cover configured to be closed above the first surface of the semiconductor material; and
a mechanism configured to apply a downward pressure on the cover to aid in forming a seal between the semiconductor material and the sealing component.

28. The apparatus of claim 17, wherein the chamber comprises a plurality of chambers beneath the sealing component configured to form a pressure differential in the fluid between the first surface of the semiconductor material positioned against the sealing component and the second surface of the semiconductor material opposite the first surface, and
wherein the sensor comprises a plurality of sensors comprising at least one sensor per chamber of the plurality of chambers, and a respective sensor from a plurality of sensors senses a change in the pressure differential for a respective portion of the semiconductor material that corresponds to the respective sensor.

29. The apparatus of claim 17, wherein the semiconductor material is a wafer and comprises a diameter of at least one of 100 mm, 150 mm, and 200 mm.

30. The apparatus of claim 17, wherein the semiconductor material comprises a silicon carbide wafer.

31. The apparatus of claim 17, wherein the defect comprises a micropipe.
